(19) United States
(12) Patent Application Publication
(10) Pub. No.: US 2012/0296789 A1
(43) Pub. Date: Nov. 22, 2012

(54) SYSTEMS AND METHODS FOR GAME MECHANIC DRIVEN MANAGEMENT

(76) Inventor: Michael J. Friedman, Norwalk, CT (US)

(21) Appl. No.: 13/469,585

(22) Filed: May 11, 2012

Related U.S. Application Data
(60) Provisional application No. 61/486,583, filed on May 16, 2011.

(51) Int. Cl. G06Q 40/00

(52) U.S. Cl. 705/35

(57) ABSTRACT

A method and a payment card account management system are provided. The payment card account management system is programmed to receive payment card account command instructions from a cardholder associated with the payment card account wherein the command instructions relate to at least one of payment card account management by the cardholder and account usage by the cardholder, generate an avatar expression based on the received command instructions, and display the generated avatar expression to the cardholder.

### CROSS REFERENCE TO RELATED APPLICATIONS

This application claims the benefit of U.S. Provisional Patent Application No. 61/486,583 filed May 16, 2011, which is hereby incorporated by reference in its entirety.

### BACKGROUND OF THE INVENTION

The field of the invention relates generally to methods and systems for managing a payment card account and, more particularly, to network-based methods and systems for using game mechanics to incentivize positive account management behaviors.

At least some known payment cardholders are not diligent at monitoring the status of their payment card accounts. For example, a cardholder may continue to use their payment card for purchases while not knowing a balance of the account or an amount of credit still available on the account. Such use can result in over drawing the account or exceeding a credit limit on the account, which in turn can result in extra fees being applied to the account or detrimental effects to the cardholder's credit rating. Additionally, such negative behavior may also represent a cost to merchant banks and the issuer bank associated with the account. Many methods have been used to encourage cardholders to manage their accounts more responsibly. Positive behaviors may include, but are not limited to, regular checking of the account balance, using online or automatic bill payments, achievement of targets, such as meeting account balance goals and/or paying bills on time, and registration of offered products, such as, mobile application downloads.

Younger demographic cardholders may respond to different methods of encouraging positive account management behaviors as compared to more traditional cardholders. Younger cardholders tend to use on-line methods more readily than traditional cardholders. Additionally, younger cardholders have been exposed to game technology and are more receptive to its use as compared to the more traditional cardholders. Methods that incorporate on-line use and game mechanics to incentivize positive account management of payment card accounts have until now been untried.

### BRIEF DESCRIPTION OF THE INVENTION

In one embodiment, a payment card account management system for use with a payment card interchange network is provided. The system includes a memory device and a processor in communication with the memory device wherein the payment card account management system is programmed to receive payment card account command instructions from a cardholder associated with the payment card account. The command instructions relate to at least one of payment card account management by the cardholder and account usage by the cardholder. The system is further programmed to generate an avatar expression based on the received command instructions and display the generated avatar expression to the cardholder.

In another embodiment, a computer-based method for managing a payment card account to a cardholder is provided. The system uses a computer device coupled to a database. The method includes receiving payment card account command instructions from a cardholder associated with the payment card account wherein the command instructions relate to at least one of payment card account management by the cardholder and account usage by the cardholder, generating an avatar expression based on the received command instructions, and displaying the generated avatar expression to the cardholder.

In yet another embodiment, one or more non-transitory computer-readable storage media having computer-executable instructions embodied thereon is provided. The instructions are executed by at least one processor causing the processor to receive payment card account command instructions from a cardholder associated with the payment card account. The command instructions relate to at least one of payment card account management by the cardholder and account usage by the cardholder. The computer-executable instructions further cause the processor to generate an avatar expression based on the received command instructions and display the generated avatar expression to the cardholder.

### BRIEF DESCRIPTION OF THE DRAWINGS

FIGS. 1-9 show exemplary embodiments of the methods and systems described herein.

FIG. 1 is a schematic diagram illustrating an exemplary multi-party payment card industry system for enabling ordinary payment-by-card transactions in which merchants and card issuers do not necessarily have a one-to-one relationship.

FIG. 2 is a simplified block diagram of an exemplary system including a plurality of computer devices in accordance with one example embodiment of the present invention.

FIG. 3 is an expanded block diagram of an exemplary embodiment of a server architecture of the system including the plurality of computer devices in accordance with one example embodiment of the present invention.

FIG. 4 illustrates an exemplary configuration of a client system shown in FIGS. 2 and 3.

FIG. 5 illustrates an exemplary configuration of a server system shown in FIGS. 2 and 3.

FIG. 6 is a schematic block diagram of the payment card account management system shown in FIG. 2 in accordance with an exemplary embodiment of the present invention.

FIG. 7 is a data flow diagram of the payment card account management system shown in FIG. 2 in accordance with an exemplary embodiment of the present invention.

FIG. 8 is a schematic view illustrating exemplary avatars that may be used with embodiments of the present invention.

FIG. 9 is a flow diagram of a computer-based method for managing a payment card account using a computer device coupled to a database.

### DETAILED DESCRIPTION OF THE INVENTION

Embodiments of the present invention combine game mechanics and an avatar-focused user interface to encourage positive and responsible payment card account management behavior.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), key fobs, and/or computers. Each type of transactions card can be used as a method of payment for performing a transaction. In addition, consumer card account behavior can include but is not limited to purchases, management activities (e.g. balance checking), bill payments, achievement of targets (meeting account balance goals, paying bills on time), product registrations (e.g. mobile application downloads).

In one embodiment, a computer program is provided, and the program is embodied on a computer readable medium. In an exemplary embodiment, the system is executed on a single computer system, without requiring a connection to a sever computer. In a further exemplary embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of AT&T located in New York, N.Y.). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

The following detailed description illustrates embodiments of the invention by way of example and not by way of limitation. It is contemplated that the invention has general application to processing financial transaction data by a third party in industrial, commercial, and residential applications.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present invention are not intended to be interpreted as excluding the existence of additional embodiments that also incorporate the recited features.

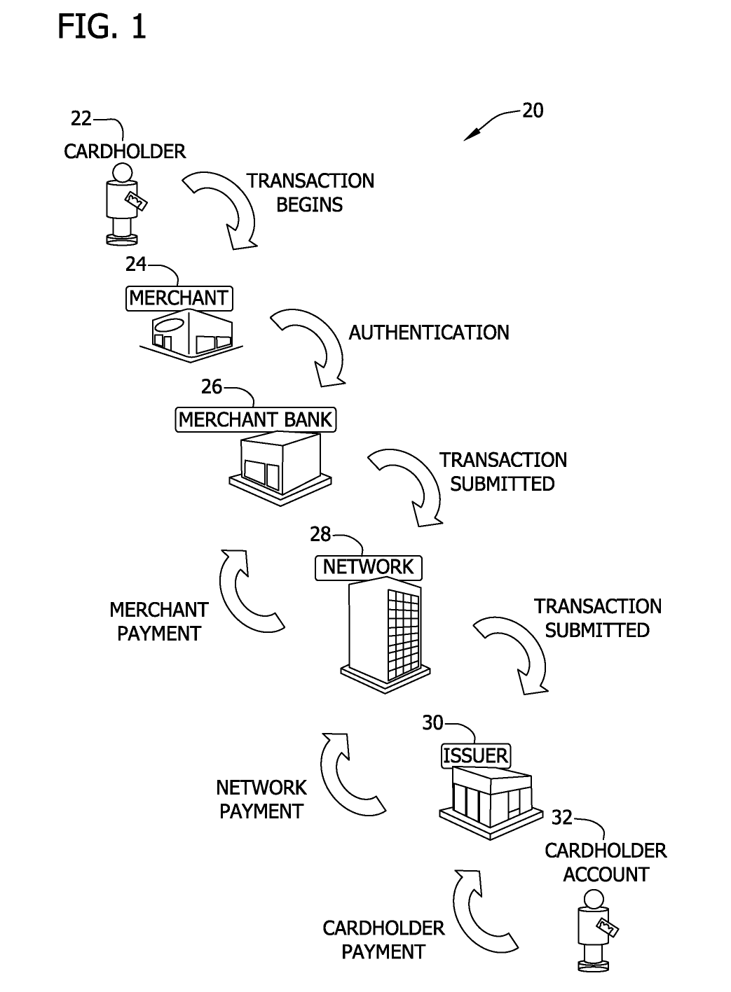

FIG. 1 is a schematic diagram illustrating an exemplary multi-party transaction card industry system 20 for enabling ordinary payment-by-card transactions in which merchants 24 and card issuers 30 do not need to have a one-to-one special relationship. Embodiments described herein may relate to a transaction card system, such as a credit card payment system using the MasterCard® interchange network. The MasterCard® interchange network is a set of proprietary communications standards promulgated by MasterCard International Incorporated® for the exchange of financial transaction data and the settlement of funds between financial institutions that are members of MasterCard International Incorporated®. (MasterCard is a registered trademark of MasterCard International Incorporated located in Purchase, N.Y.).

In a typical transaction card system, a financial institution called the “issuer” issues a transaction card, such as a credit card, to a consumer or cardholder 22, who uses the transaction card to tender payment for a purchase from a merchant 24. To accept payment with the transaction card, merchant 24 must normally establish an account with a financial institution that is part of the financial payment system. This financial institution is usually called the “merchant bank,” the “acquiring bank,” or the “acquirer.” When cardholder 22 tenders payment for a purchase with a transaction card, merchant 24 requests authorization from a merchant bank 26 for the amount of the purchase. The request may be performed over the telephone, but is usually performed through the use of a point-of-sale terminal, which reads cardholder's 22 account information from a magnetic stripe, a chip, or embossed characters on the transaction card and communicates electronically with the transaction processing computers of merchant bank 26. Alternatively, merchant bank 26 may authorize a third party to perform transaction processing on its behalf. In this case, the point-of-sale terminal will be configured to communicate with the third party. Such a third party is usually called a “merchant processor,” an “acquiring processor,” or a “third party processor.”

Using an interchange network 28, computers of merchant bank 26 or merchant processor will communicate with computers of an issuer bank 30 to determine whether cardholder's 22 account 32 is in good standing and whether the purchase is covered by cardholder's 22 available credit line. Based on these determinations, the request for authorization will be declined or accepted. If the request is accepted, an authorization code is issued to merchant 24.

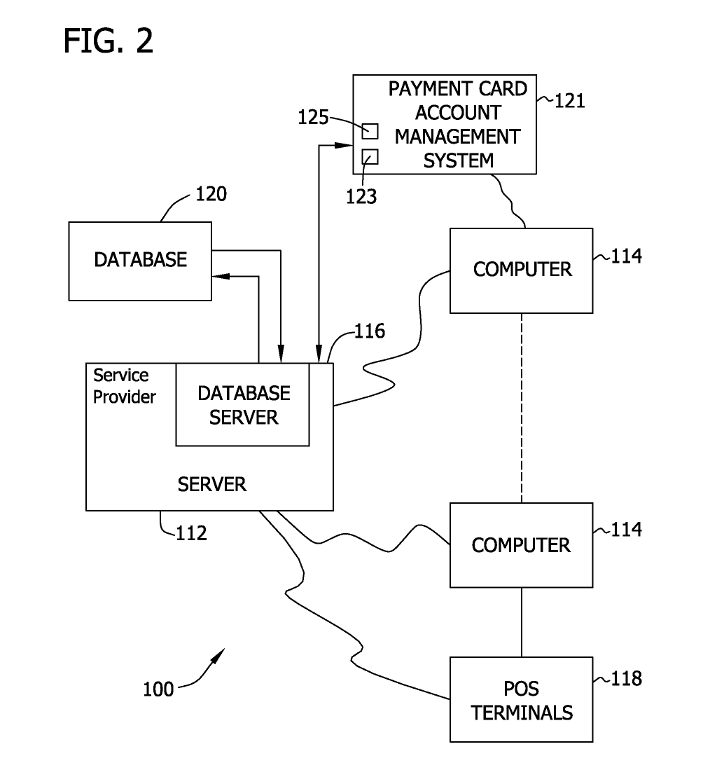

When a request for authorization is accepted, the available credit line of cardholder's 22 account 32 is decreased. Normally, a charge for a payment card transaction is not posted immediately to cardholder's 22 account 32 because bankcard associations, such as MasterCard International Incorporated®, have promulgated rules that do not allow merchant 24 to charge, or “capture,” a transaction until goods are shipped or services are delivered. However, with respect to at least some debit card transactions, a charge may be posted at the time of the transaction. When merchant 24 ships or delivers the goods or services, merchant 24 captures the transaction by, for example, appropriate data entry procedures on the point-of-sale terminal This may include bundling of approved transactions daily for standard retail purchases. If cardholder 22 cancels a transaction before it is captured, a “void” is generated. If cardholder 22 returns goods after the transaction has been captured, a “credit” is generated. Interchange network 28 and/or issuer bank 30 stores the transaction card information, such as a type of merchant, amount of purchase, date of purchase, in a database 120 (shown in FIG. 2).

After a purchase has been made, a clearing process occurs to transfer additional transaction data related to the purchase among the parties to the transaction, such as merchant bank 26, interchange network 28, and issuer bank 30. More specifically, during and/or after the clearing process, additional data, such as a time of purchase, a merchant name, a type of merchant, purchase information, cardholder account information, a type of transaction, itinerary information, information regarding the purchased item and/or service, and/or other suitable information, is associated with a transaction and transmitted between parties to the transaction as transaction data, and may be stored by any of the parties to the transaction. In the exemplary embodiment, when cardholder 22 purchases travel, such as airfare, a hotel stay, and/or a rental car, at least partial itinerary information is transmitted during the clearance process as transaction data. When interchange network 28 receives the itinerary information, interchange network 28 routes the itinerary information to database 120.

After a transaction is authorized and cleared, the transaction is settled among merchant 24, merchant bank 26, and issuer bank 30. Settlement refers to the transfer of financial data or funds among merchant's 24 account, merchant bank 26, and issuer bank 30 related to the transaction. Usually, transactions are captured and accumulated into a “batch,” which is settled as a group. More specifically, a transaction is typically settled between issuer bank 30 and interchange network 28, and then between interchange network 28 and merchant bank 26, and then between merchant bank 26 and merchant 24.

FIG. 2 is a simplified block diagram of an exemplary processing system 100 including a plurality of computer devices in accordance with one embodiment of the present invention. In the example embodiment, system 100 may be used for performing payment-by-card transactions received as of part processing the financial transaction.

More specifically, in the example embodiment, system 100 includes a server system 112, and a plurality of client sub-systems, also referred to as client systems 114, connected to server system 112. In one embodiment, client systems 114 are computers including a web browser, such that server system 112 is accessible to client systems 114 using the Internet. Client systems 114 are interconnected to the Internet through many interfaces including a network, such as a local area network (LAN) or a wide area network (WAN), dial-in-connections, cable modems, and special high-speed Integrated Services Digital Network (ISDN) lines. Client systems 114 could be any device capable of interconnecting to the Internet including a web-based phone, PDA, or other web-based connectable equipment.

System 100 also includes point-of-sale (POS) terminals 118, which may be connected to client systems 114 and may be connected to server system 112. POS terminals 118 are interconnected to the Internet through many interfaces including a network, such as a local area network (LAN) or a wide area network (WAN), dial-in-connections, cable modems, wireless modems, and special high-speed ISDN lines. POS terminals 118 could be any device capable of interconnecting to the Internet and including an input device capable of reading information from a consumer's financial transaction card.

A database server 116 is connected to database 120, which contains information on a variety of matters, as described below in greater detail. In one embodiment, centralized database 120 is stored on server system 112 and can be accessed by potential users at one of client systems 114 by logging onto server system 112 through one of client systems 114. In an alternative embodiment, database 120 is stored remotely from server system 112 and may be non-centralized.

Database 120 may include a single database having separated sections or partitions or may include multiple databases, each being separate from each other. Database 120 may store transaction data generated as part of sales activities conducted over the processing network including data relating to merchants, account holders or customers, issuers, acquirers, purchases made. Database 120 may also store account data including at least one of a cardholder name, a cardholder address, an account number, and other account identifier. Database 120 may also store merchant data including a merchant identifier that identifies each merchant registered to use the network, and instructions for settling transactions including merchant bank account information. Database 120 may also store purchase data associated with items being purchased by a cardholder from a merchant, and authorization request data.

In the examplary embodiment, one of client systems 114 may be associated with acquirer bank 26 (shown in FIG. 1) while another one of client systems 114 may be associated with issuer bank 30 (shown in FIG. 1). POS terminal 118 may be associated with a participating merchant 24 (shown in FIG. 1) or may be a computer system and/or mobile system used by a cardholder making an on-line purchase or payment. Server system 112 may be associated with interchange network 28. In the exemplary embodiment, server system 112 is associated with a network interchange, such as interchange network 28, and may be referred to as an interchange computer system. Server system 112 may be used for processing transaction data. In addition, client systems 114 and/or POS 118 may include a computer system associated with at least one of an online bank, a bill payment outsourcer, an acquirer bank, an acquirer processor, an issuer bank associated with a transaction card, an issuer processor, a remote payment system, and/or a biller. Further, a payment card account management system 121 may be included in client systems 114 or optionally may be included in server system 112. In various embodiments, payment card account management system 121 may be associated with a standalone processor or may be associated with a separate third party provider in a contractual relationship with interchange network 28 and configured to perform the functions described herein. Accordingly, each party involved in processing transaction data are associated with a computer system shown in system 100 such that the parties can communicate with one another as described herein.

Using the interchange network, the computers of the merchant bank or the merchant processor will communicate with the computers of the issuer bank to determine whether the consumer's account is in good standing and whether the purchase is covered by the consumer's available credit line. Based on these determinations, the request for authorization will be declined or accepted. If the request is accepted, an authorization code is issued to the merchant.

When a request for authorization is accepted, the available credit line of consumer's account is decreased. Normally, a charge is not posted immediately to a consumer's account because bankcard associations, such as MasterCard International Incorporated®, have promulgated rules that do not allow a merchant to charge, or “capture,” a transaction until goods are shipped or services are delivered. When a merchant ships or delivers the goods or services, the merchant captures the transaction by, for example, appropriate data entry procedures on the point-of-sale terminal If a consumer cancels a transaction before it is captured, a “void” is generated. If a consumer returns goods after the transaction has been captured, a “credit” is generated.

For debit card transactions, when a request for a PIN authorization is approved by the issuer, the consumer's account is decreased. Normally, a charge is posted immediately to a consumer's account. The bankcard association then transmits the approval to the acquiring processor for distribution of goods/services, or information or cash in the case of an ATM.

After a transaction is captured, the transaction is settled between the merchant, the merchant bank, and the issuer. Settlement refers to the transfer of financial data or funds between the merchant's account, the merchant bank, and the issuer related to the transaction. Usually, transactions are captured and accumulated into a “batch,” which is settled as a group.

The financial transaction cards or payment cards discussed herein may include credit cards, debit cards, a charge card, a membership card, a promotional card, prepaid cards, and gift cards. These cards can all be used as a method of payment for performing a transaction. As described herein, the term “financial transaction card” or “payment card” includes cards such as credit cards, debit cards, and prepaid cards, but also includes any other devices that may hold payment account information, such as mobile phones, personal digital assistants (PDAs), key fobs, or other devices, etc.

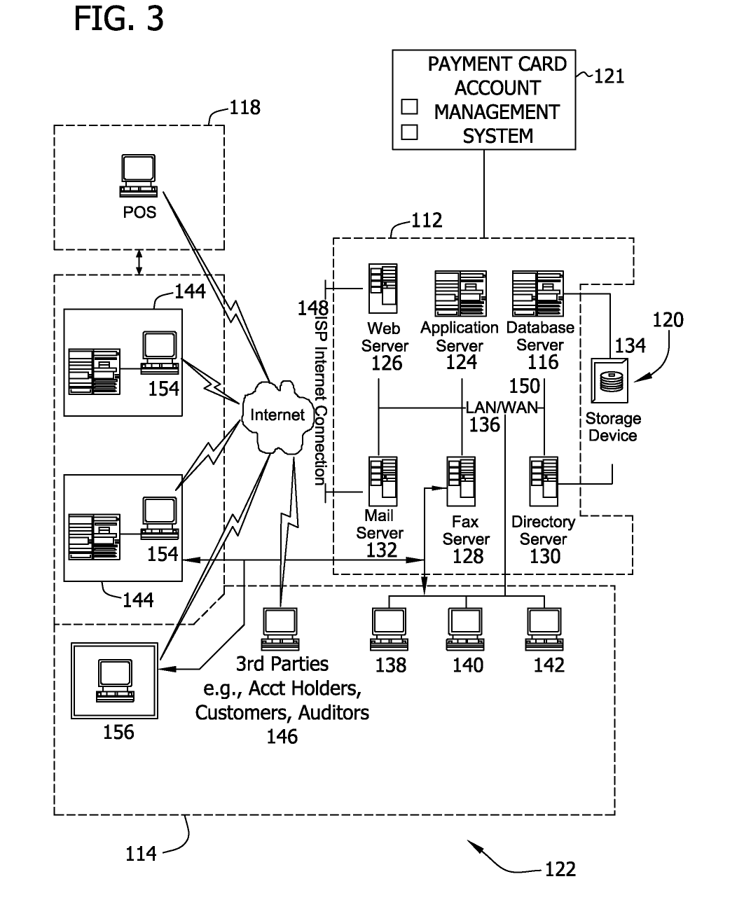

FIG. 3 is an expanded block diagram of an exemplary embodiment of a server architecture of a processing system 122 including other computer devices in accordance with one embodiment of the present invention. Components in system 122, identical to components of system 100 (shown in FIG. 2), are identified in FIG. 3 using the same reference numerals as used in FIG. 2. System 122 includes server system 112, client systems 114, and POS terminals 118, and payment card account management system 121. Server system 112 further includes database server 116, a transaction server 124, a web server 126, a fax server 128, a directory server 130, and a mail server 132. A storage device 134 is coupled to database server 116 and directory server 130. Servers 116, 124, 126, 128, 130, and 132 are coupled in a local area network (LAN) 136. In addition, a system administrator's workstation 138, a user workstation 140, and a supervisor's workstation 142 are coupled to LAN 136. Alternatively, workstations 138, 140, and 142 are coupled to LAN 136 using an Internet link or are connected through an Intranet.

Each workstation, 138, 140, and 142 is a personal computer having a web browser. Although the functions performed at the workstations typically are illustrated as being performed at respective workstations 138, 140, and 142, such functions can be performed at one of many personal computers coupled to LAN 136. Workstations 138, 140, and 142 are illustrated as being associated with separate functions only to facilitate an understanding of the different types of functions that can be performed by individuals having access to LAN 136.

Server system 112 is configured to be communicatively coupled to various individuals, including employees 144 and to third parties, e.g., account holders, customers, auditors, developers, consumers, merchants, acquirers, issuers, etc., 146 using an ISP Internet connection 148. The communication in the exemplary embodiment is illustrated as being performed using the Internet, however, any other wide area network (WAN) type communication can be utilized in other embodiments, i.e., the systems and processes are not limited to being practiced using the Internet. In addition, and rather than WAN 150, local area network 136 could be used in place of WAN 150.

In the exemplary embodiment, any authorized individual having a workstation 154 can access system 122. At least one of the client systems includes a manager workstation 156 located at a remote location. Workstations 154 and 156 are personal computers having a web browser. Also, workstations 154 and 156 are configured to communicate with server system 112. Furthermore, fax server 128 communicates with remotely located client systems, including a client system 156 using a telephone link. Fax server 128 is configured to communicate with other client systems 138, 140, and 142 as well.

Payment card account management system 121 is in communication with server system 112 and in communication with client systems 114 and other workstations through a network connection.

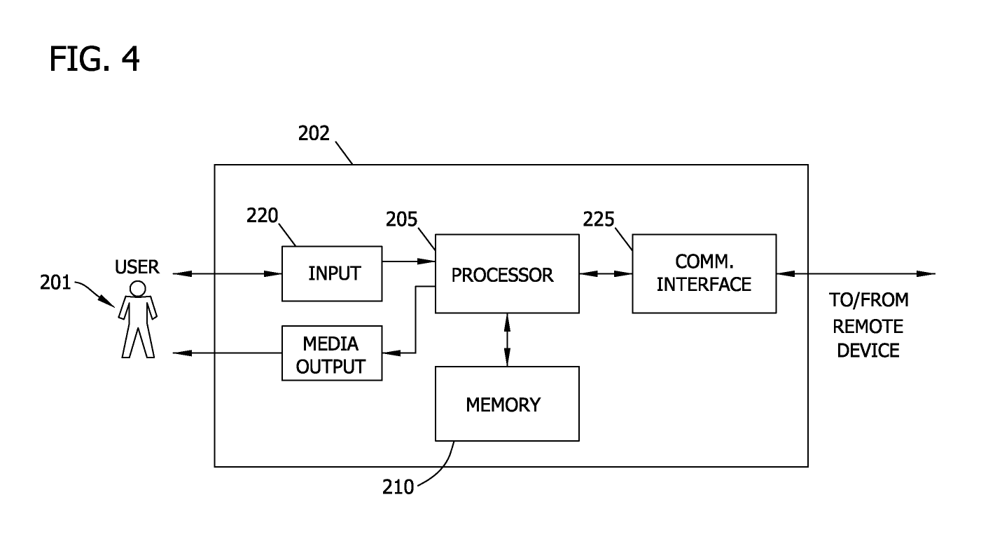

FIG. 4 illustrates an exemplary configuration of a user system 202 operated by a user 201, such as cardholder 22 (shown in FIG. 1). User system 202 may include, but is not limited to, client systems 114, 138, 140, and 142, POS terminal 118, workstation 154, and manager workstation 156. In the exemplary embodiment, user system 202 includes a processor 205 for executing instructions. In some embodiments, executable instructions are stored in a memory area 210. Processor 205 may include one or more processing units, for example, a multi-core configuration. Memory area 210 is any device allowing information such as executable instructions and/or written works to be stored and retrieved. Memory area 210 may include one or more computer readable media.

User system 202 also includes at least one media output component 215 for presenting information to user 201. Media output component 215 is any component capable of conveying information to user 201. In some embodiments, media output component 215 includes an output adapter such as a video adapter and/or an audio adapter. An output adapter is operatively coupled to processor 205 and operatively couplable to an output device such as a display device, a liquid crystal display (LCD), organic light emitting diode (OLED) display, or “electronic ink” display, or an audio output device, a speaker or headphones.

In some embodiments, user system 202 includes an input device 220 for receiving input from user 201. Input device 220 may include, for example, a keyboard, a pointing device, a mouse, a stylus, a touch sensitive panel, a touch pad, a touch screen, a gyroscope, an accelerometer, a position detector, or an audio input device. A single component such as a touch screen may function as both an output device of media output component 215 and input device 220. User system 202 may also include a communication interface 225, which is communicatively couplable to a remote device such as server system 112. Communication interface 225 may include, for example, a wired or wireless network adapter or a wireless data transceiver for use with a mobile phone network, Global System for Mobile communications (GSM), 3G, or other mobile data network or Worldwide Interoperability for Microwave Access (WIMAX).

Stored in memory area 210 are, for example, computer readable instructions for providing a user interface to user 201 via media output component 215 and, optionally, receiving and processing input from input device 220. A user interface may include, among other possibilities, a web browser and client application. Web browsers enable users, such as user 201, to display and interact with media and other information typically embedded on a web page or a website from server system 112. A client application allows user 201 to interact with a server application from server system 112.

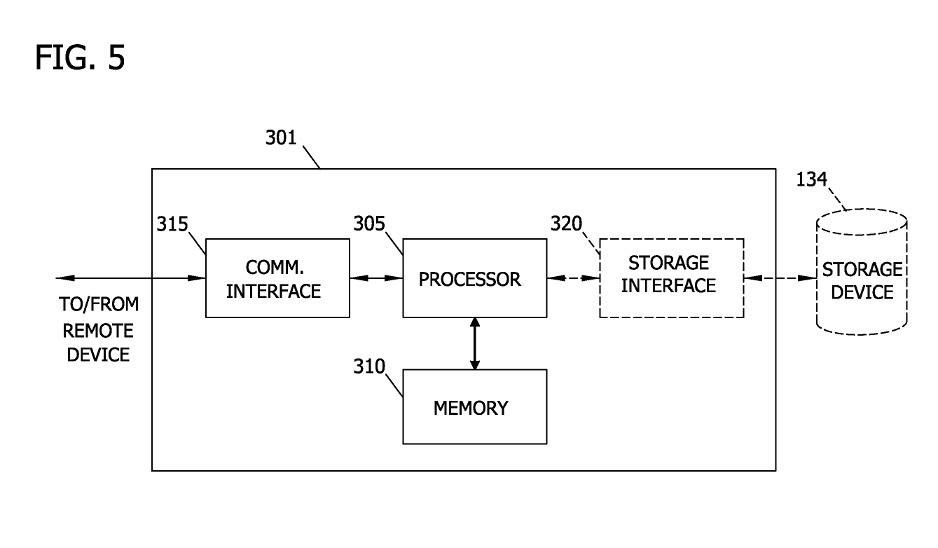

FIG. 5 illustrates an exemplary configuration of a server system 301 such as server system 112 (shown in FIGS. 2 and 3). Server system 301 may include, but is not limited to, database server 116, transaction server 124, web server 126, fax server 128, directory server 130, and mail server 132.

Server system 301 includes a processor 305 for executing instructions. Instructions may be stored in a memory area 310, for example. Processor 305 may include one or more processing units (e.g., in a multi-core configuration) for executing instructions. The instructions may be executed within a variety of different operating systems on the server system 301, such as UNIX, LENUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc).

Processor 305 is operatively coupled to a communication interface 315 such that server system 301 is capable of communicating with a remote device such as a user system or another server system 301. For example, communication interface 315 may receive requests from user system 114 via the Internet, as illustrated in FIGS. 2 and 3.

Processor 305 may also be operatively coupled to a storage device 134. Storage device 134 is any computer-operated hardware suitable for storing and/or retrieving data. In some embodiments, storage device 134 is integrated in server system 301. For example, server system 301 may include one or more hard disk drives as storage device 134. In other embodiments, storage device 134 is external to server system 301 and may be accessed by a plurality of server systems 301. For example, storage device 134 may include multiple storage units such as hard disks or solid state disks in a redundant array of inexpensive disks (RAID) configuration. Storage device 134 may include a storage area network (SAN) and/or a network attached storage (NAS) system.

In some embodiments, processor 305 is operatively coupled to storage device 134 via a storage interface 320. Storage interface 320 is any component capable of providing processor 305 with access to storage device 134. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 134.

Memory area 310 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

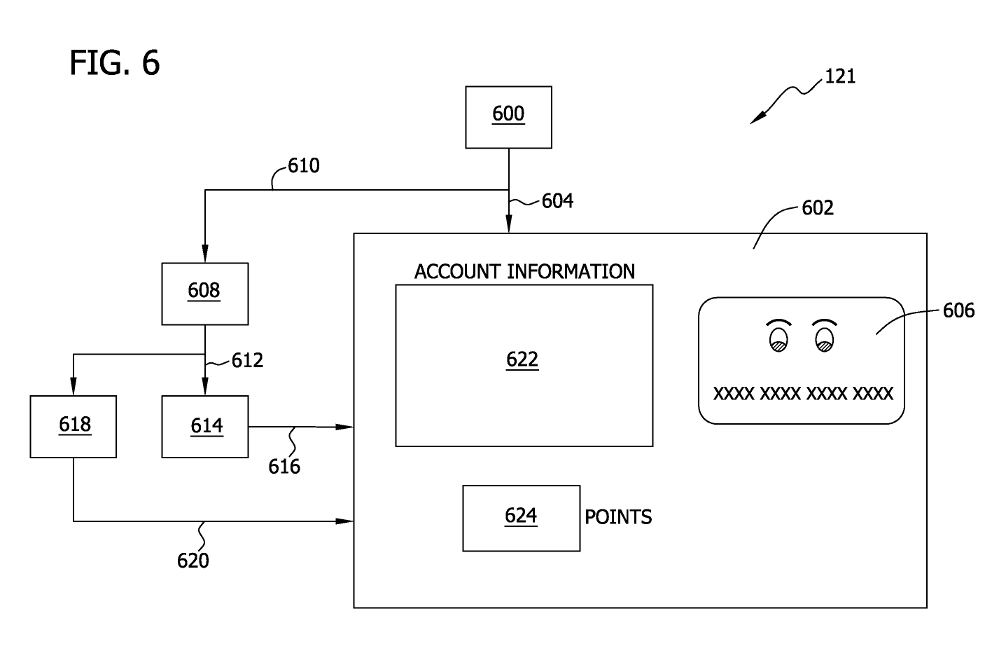

FIG. 6 is a schematic block diagram of a payment card account management system 121 (shown in FIG. 2) in accordance with an exemplary embodiment of the present invention. In the exemplary embodiment, payment card account management system 121 includes a data store 600 containing account information, a user interface (UI) 602 configured to receive the account information 604 from data store 600 and to convey the account information 604 to a user, a virtual representation or avatar 606 of the user's card account, a cardholder action scoring database 608 configured to convert consumer card account usage 610 into cardholder action scores 612, a cardholder action score to avatar behavior database 614 configured to convert the scores 612 into avatar and UI behaviors 616, and a cardholder action score to points database 618 configured to convert scores 612 into points 620. Account information is displayed in a card account management user interface 622 portion of UI 602 and points 620 are displayed in a point display portion 624 of UI 602. Avatar 606 may be a fanciful representation of a payment card having expressions or actions that tend to elicit a positive account management behavior by the user or cardholder. In various embodiments, avatar 606 may be image files uploaded by the user that correspond to the available moods of avatar 606. The uploaded image files may represent any object that facilitates incentivizing positive account management behavior. The image files may also include an animated image file such as those having for example, a .gif suffix. Additionally, avatar 606 may be associated with an aural or sound output provided by payment card account management system 121, selectable by the user, or uploaded by the user. For example, in conjunction with a happy card avatar 606, cheering and clapping may be aurally presented to the user. Furthermore, other aspects of UI 602 may be associated with the avatar behaviors. For example, a background displayed on UI 602 may change to an image of a blue sky and white clouds in response to positive account behaviors by the user or may change to a dark sky and ominous clouds in response to negative account behaviors by the user.

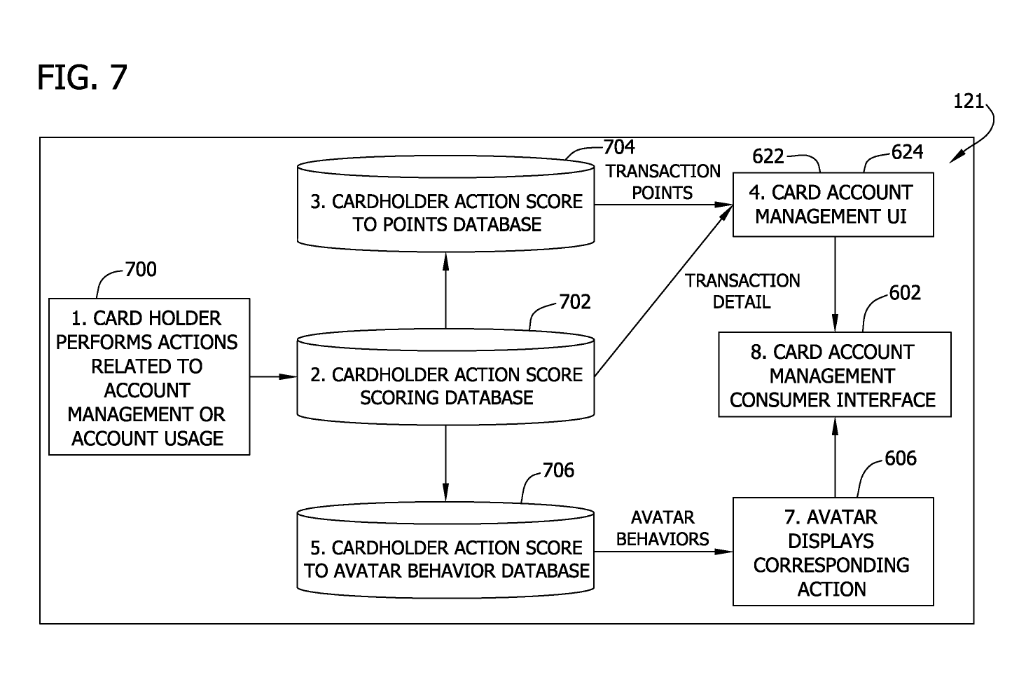

FIG. 7 is a flow diagram of a payment card account management system 121 (shown in FIG. 2) in accordance with an exemplary embodiment of the present invention. In the exemplary embodiment, a user interacts 700 with the payment card account associated with the user. Payment card account management system 121 translates 702 the payment card account behavior into a score using information stored in cardholder action scoring database 608 (shown in FIG. 6). The score is translated 704 by a cardholder action score using cardholder action score to points database 618 to determine the number of points earned or lost by the consumer. These points and the corresponding behavior are presented to the consumer through the card account management user interface 622. Concurrently, the cardholder action score is analyzed using cardholder action score to avatar behavior database 614. Cardholder action scores are converted 706 in cardholder action score to avatar behavior database 614 to avatar behaviors 606 depicted on UI 602.

Card account behaviors that are determined to be positive result in beneficial effects on the consumers point value and the avatar's behavior or environment. For example, meeting responsible purchase and balance management targets may make the avatar happy, beneficially enhance the UI, award digital gifts, and/or provide other position incentives to encourage the behavior. Payment card account behaviors that are determined to be negative, for example, but not limited to exceeding credit limits, have a negative effect on the consumers point value and the avatar's behavior or environment.

In one embodiment, UI 602 may be accessed and displayed on a PC or client workstation, such as, but not limited to, client system 114 connected to server system 112. In various embodiments, UI 602 may be accessed via an app downloaded to a portable handheld device such as, but not limited to, a Smartphone.

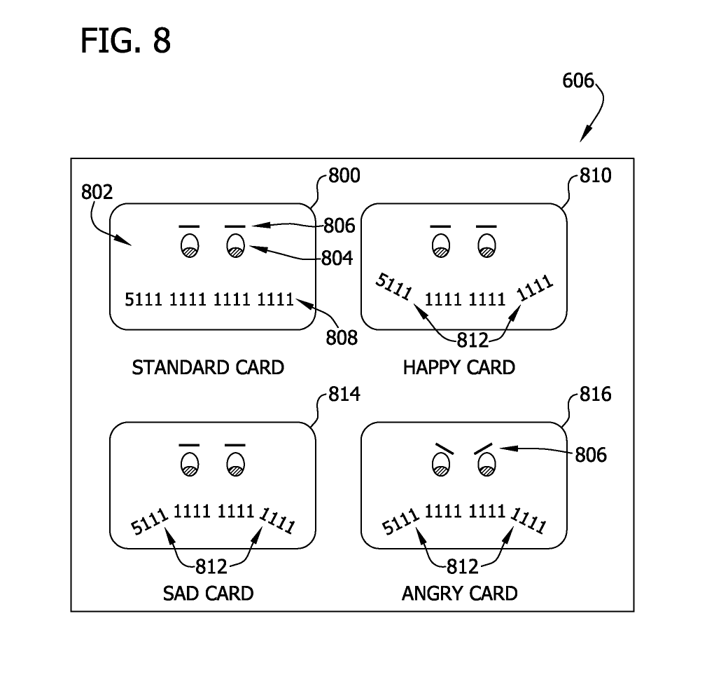

FIG. 8 is a schematic view illustrating exemplary avatars 606 that may be used with embodiments of the present invention. In one embodiment, a standard card avatar 800 illustrates an avatar face 802 constructed using eyes 804, eyebrows 806, and a mouth 808 formed of, for example, the payment card account number digits. Standard card avatar 800 may be displayed when the payment card account behaviors performed by the user are neutral with respect to incentivized behaviors, when the payment card account behaviors have been negative and are trending positive, or have been positive and are trending negative. A happy card avatar 810 may be displayed when the payment card account behaviors performed by the user are positive with respect to incentivized behaviors or when the payment card account behaviors are trending positive. In the exemplary embodiment, the corners 812 of mouth 808 are upturned representative of a smiling or happy avatar 810. A sad card avatar 814 may be displayed when the payment card account behaviors performed by the user are negative with respect to incentivized behaviors or when the payment card account behaviors are trending negative. In the exemplary embodiment, the corners 812 of mouth 808 are downturned representative of a frowning or sad avatar 810. An angry card avatar 816 may be displayed when the payment card account behaviors performed by the user are very negative with respect to incentivized behaviors, when the user has violated one or more terms of the account contract, or when the payment card account behaviors have been trending negative for a predetermined time period. In the exemplary embodiment, the corners 812 of mouth 808 are downturned and eyebrows 806 are furrowed representative of an angry avatar 810.

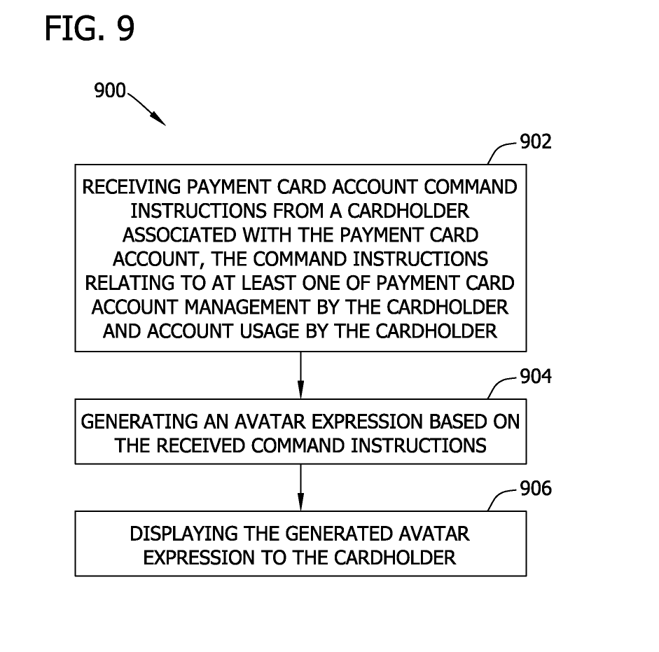

FIG. 9 is a flow diagram of a computer-based method 900 for managing a payment card account using a computer device coupled to a database. In the exemplary embodiment, method 900 includes receiving 902 payment card account command instructions from a cardholder associated with the payment card account, the command instructions relating to at least one of payment card account management by the cardholder and account usage by the cardholder. Method 900 further includes generating 904 an avatar expression based on the received command instructions and displaying 906 the generated avatar expression to the cardholder.

The term processor, as used herein, refers to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are exemplary only, and are thus not limiting as to the types of memory usable for storage of a computer program.

As will be appreciated based on the foregoing specification, the above-described embodiments of the disclosure may be implemented using computer programming or engineering techniques including computer software, firmware, hardware or any combination or subset thereof, wherein the technical effect is receiving payment card account command instructions from a cardholder associated with the payment card account wherein the command instructions relate to at least one of payment card account management by the cardholder and account usage by the cardholder, generating an avatar expression based on the received command instructions, and displaying the generated avatar expression to the cardholder. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

The above-described embodiments of a method and system of managing a payment card account provides a cost-effective and reliable means for providing incentives for cardholders that manage their payment card account in a positive manner by exhibiting behaviors that are associated with such management. As a result, the methods and systems described herein facilitate encouraging positive and responsible card account usage and behavior employing virtual representations of the card account and game mechanics in a cost-effective and reliable manner.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A payment card account management system for use with a payment card interchange network, said system comprising a memory device and a processor in communication with the memory device, the payment card account management system is programmed to:
receive payment card account command instructions from a cardholder associated with the payment card account, the command instructions relating to at least one of payment card account management by the cardholder and account usage by the cardholder;
generate an avatar expression based on the received command instructions; and
display the generated avatar expression to the cardholder.

2. A system in accordance with claim 1, wherein the payment card account management system is further programmed to generate the avatar expression using game mechanics.

3. A system in accordance with claim 1, wherein the payment card account management system is further programmed to associate a payment card account behavior with the account command instructions.

4. A system in accordance with claim 3, wherein the payment card account management system is further programmed to determine a cardholder action score using the payment card account behavior.

5. A system in accordance with claim 3, wherein the payment card account management system is further programmed to determine a number of points earned or lost by the cardholder using the determined cardholder action score.

6. A system in accordance with claim 3, wherein the payment card account management system is further programmed to determine at least one of an avatar behavior and an avatar environment for display using the determined cardholder action score.

7. A system in accordance with claim 1, wherein the payment card account management system is further programmed to receive image files that correspond to available moods of the avatar wherein the moods are used to generate the avatar expression.

8. A computer-based method for managing a payment card account using a computer device coupled to a database, said method comprising:
receiving payment card account command instructions from a cardholder associated with the payment card account, the command instructions relating to at least one of payment card account management by the cardholder and account usage by the cardholder;
generating an avatar expression based on the received command instructions; and
displaying the generated avatar expression to the cardholder.

9. A method in accordance with claim 8, wherein generating an avatar expression comprises generating the avatar expression using game mechanics.

10. A method in accordance with claim 8, further comprising associating a payment card account behavior with the account command instructions.

11. A method in accordance with claim 10, further comprising determining a cardholder action score using the payment card account behavior.

12. A method in accordance with claim 10, further comprising determining a number of points earned or lost by the cardholder using the determined cardholder action score.

13. A method in accordance with claim 10, further comprising determining at least one of an avatar behavior and an avatar environment for display using the determined cardholder action score.

14. A method in accordance with claim 8, further comprising receiving image files that correspond to available moods of the avatar wherein the moods are used to generate the avatar expression.

15. One or more non-transitory computer-readable storage media having computer-executable instructions embodied thereon, wherein when executed by at least one processor, the computer-executable instructions cause the processor to:
receive payment card account command instructions from a cardholder associated with the payment card account, the command instructions relating to at least one of payment card account management by the cardholder and account usage by the cardholder;
generate an avatar expression based on the received command instructions; and
display the generated avatar expression to the cardholder.

16. The computer-readable storage media of claim 15, wherein the computer-executable instructions further cause the processor to generate an avatar expression using game mechanics where a plurality of rules are included in one or more databases communicatively coupled to the processor.

17. The computer-readable storage media of claim 15, wherein the computer-executable instructions further cause the processor to associate a payment card account behavior with the account command instructions.

18. The computer-readable storage media of claim 17, wherein the computer-executable instructions further cause the processor to determine a cardholder action score using the payment card account behavior.

19. The computer-readable storage media of claim 17, wherein the computer-executable instructions further cause the processor to determine a number of points earned or lost by the cardholder using the determined cardholder action score.

20. The computer-readable storage media of claim 17, wherein the computer-executable instructions further cause the processor to determine at least one of an avatar behavior and an avatar environment for display using the determined cardholder action score.
